(19) United States
(12) Patent Application Publication
(10) Pub. No.: US 2013/0077032 A1
(43) Pub. Date: Mar. 28, 2013

(54) LIQUID CRYSTAL DISPLAY DEVICE, LIQUID CRYSTAL PANEL AND METHOD FOR MANUFACTURING THE SAME

(71) Applicants: Shih-Hslang Chen, Shenzhen (CN); Yu-Bo Gu, Shenzhen (CN); Dan Xiao, Shenzhen (CN); Liu-Yang Yang, Shenzhen (CN)

(72) Inventors: Shih-Hslang Chen, Shenzhen (CN); Yu-Bo Gu, Shenzhen (CN); Dan Xiao, Shenzhen (CN); Liu-Yang Yang, Shenzhen (CN)

(21) Appl. No.: 13/377,989

(22) PCT Filed: Oct. 11, 2011
(86) PCT No.: PCT/CN2011/080638

§ 371 Date: Dec. 13, 2011

(30) Foreign Application Priority Data
Sep. 28, 2011 (CN) 201110290504.8

(51) Int. Cl. G02F 1/1339

(52) U.S. Cl. 349/122; 349/187; 349/153

(57) ABSTRACT

A liquid crystal display device, a liquid crystal panel and a method for manufacturing the same, the liquid crystal panel comprises a first substrate, a second substrate, a liquid crystal and a sealant sandwiched between the first substrate and the second substrate. A display area constituted by an arrangement of a plurality of devices and ITO areas, and a surrounding area around the display area are formed on the second substrate. Metal lines are arranged and disposed on the second substrate for electrically connecting to the devices. In addition, parts of the metal lines on the surrounding area are curved and extended, an ITO layer is formed on the parts of the metal lines on the surrounding area, and a bottom of the sealant is adhered with an upper surface of the ITO layer.

### BACKGROUND OF THE INVENTION

1. Field of Invention

The present invention relates to a liquid crystal display device and more particularly to a structure of a liquid crystal panel of a liquid crystal display device.

2. Related Art

A liquid crystal display device employs liquid crystals to display images, and typically it is constituted of a liquid crystal panel, related digital circuits and a power supply. A TFT liquid crystal panel structurally includes a liquid crystal layer sandwiched between two glass substrates, color filters are adhered on a LCD panel disposed at a front end, and thin-film transistors (TFT) are constructed on a TFT panel disposed at a back end. When the transistors are applied with a voltage, the liquid crystal molecules orient, and a backlight beam provided by a backlight module behind the liquid crystal panel is penetrated through the liquid crystals to produce a dot on the panel at the front end. Each dot is provided with a specific color by the color filters, an image presented on the panel is constituted of a plurality of dots with different colors. Moreover, a display area constituted by an arrangement of millions of TFT devices and indium tin oxide (ITO) areas, and a surrounding area or a non-display area around the display area are formed on the TFT panel. Metal lines are arranged and disposed on the TFT panel for electrically connecting to the TFT devices. The LCD panel and the TFT panel are adhered together by using a sealant, and an adhesive strength of the sealant is an important factor for determining a structural strength of the panels; therefore, manufacturers are attempting to research on how to enhance the adhesive strength of sealant. For example, U.S. Pat. No. 7,643,122 discloses a liquid crystal display device and its manufacturing method. Referring to FIG. 1, a sealant 90 is disposed above a gate insulating layer 82, the gate insulating layer 82 is disposed on the metal gate layer 25, and the sealant 90 is in contact with an organic insulating layer 86 which is disposed above the gate insulating layer 82. Because of the limitations of the sealant 90 and the organic insulating layer 86, a contacting area between the sealant 90 and the organic insulating layer 86 is reduced in the patent in order to enhance an adhesive strength of the sealant 90. However, because of the contacting area between the sealant 90 and the organic insulating layer 86 is reduced, the sealant 90 will be in contact with other layers besides the organic insulating layer 86, such as a dummy protective pattern 98. This conventional structure is rather complicated and is troublesome to be embodied.

### SUMMARY OF THE INVENTION

The present invention relates to a liquid crystal display device and more particularly to a structure of a liquid crystal panel of a liquid crystal display device.

An object of the present invention is to provide a structure of a liquid crystal panel of a liquid crystal display device, so that an adhesive strength of a sealant can be enhanced by using a more simple method.

In order to achieve the abovementioned object, the present invention provides a manufacturing method for a liquid crystal panel, comprising: disposing a first substrate, disposing a second substrate, disposing a liquid crystal and a sealant sandwiched between the first substrate and the second substrate, having a display area constituted by an arrangement of a plurality of devices and ITO areas, and a surrounding area around the display area formed on the second substrate, having metal lines arranged and disposed on the second substrate for electrically connecting to the devices, further having parts of the metal lines on the surrounding area curved and extended, having an ITO layer formed on the parts of the metal lines on the surrounding area, having a bottom of the sealant adhered with an upper surface of the ITO layer.

In order to achieve the abovementioned object, the present invention provides a liquid crystal panel, comprising a first substrate, a second substrate, a liquid crystal and a sealant sandwiched between the first substrate and the second substrate, a display area constituted by an arrangement of a plurality of devices and ITO areas, and a surrounding area around the display area formed on the second substrate. Metal lines are arranged and disposed on the second substrate for electrically connecting to the devices, and parts of the metal lines on the surrounding area are curved and extended. In addition, an ITO layer is formed on the parts of the metal lines on the surrounding area, a bottom of the sealant is adhered with an upper surface of the ITO layer.

In order to achieve the abovementioned object, the present invention provides a liquid crystal display device, comprising the abovementioned liquid crystal panel.

Comparing with conventional technique, a liquid crystal display device, a liquid crystal panel and its manufacturing method of the present invention having the parts of the metal lines on the surrounding area curved and extended, so that it is very convenient for the ITO layer formed on the metal lines on the surrounding area to have an uneven upper surface, in order to increase a contact area between the sealant and the ITO layer, therefore by using a more simple method the adhesive strength of the sealant can be enhanced.

### BRIEF DESCRIPTION OF THE DRAWINGS

FIG. 1 is a cross-sectional view of a structure of a conventional liquid crystal panel;

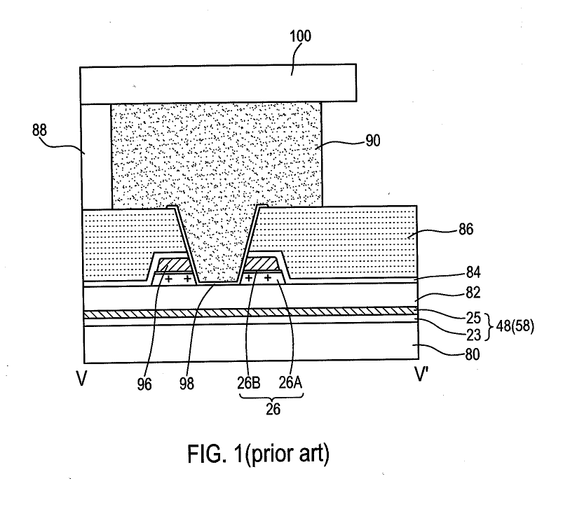

FIGS. 2a, 2b and 2c are structural illustrations of three different shapes of metal lines of a liquid crystal panel of the present invention; and

FIG. 3 is a cross-sectional view of metal lines taken along a line A-A shown on FIG. 2a.

### DETAILED DESCRIPTION OF THE INVENTION

The present invention will become more fully understood by reference to the following detailed description thereof when read in conjunction with the attached drawings.

The present invention provides a manufacturing method for a liquid crystal panel, by having parts of metal lines curved and extended on a surrounding area of a TFT panel, so that it is very convenient for an ITO layer with an uneven upper surface formed on the metal lines on the surrounding area, in order to increase a contact area between a bottom of a sealant and an upper surface of the ITO layer, by which an adhesive strength of the sealant can be enhanced.

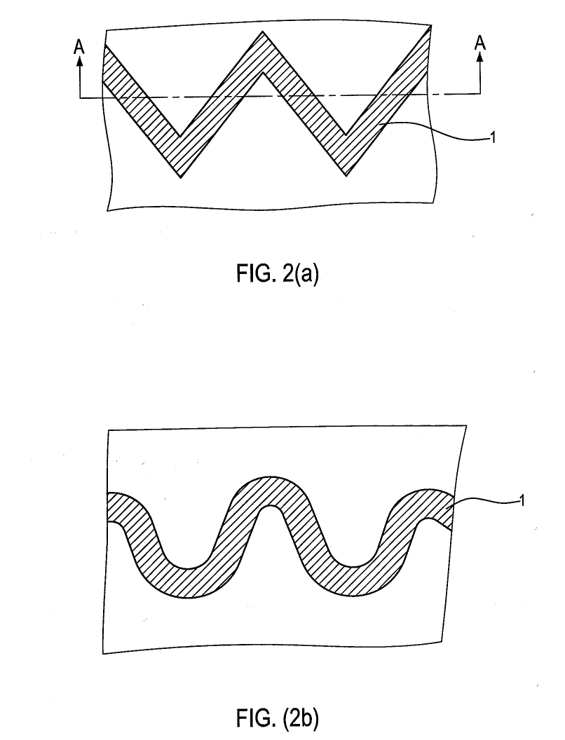

Referring to FIGS. 2a, 2b and 2c, a shape of a part 1 of a metal line on a surrounding area can be a sawtooth shape, a wave shape, or a square-wave shape.

It should be noted that, a purpose for the curved and extended design of the part 1 of the metal line on the surrounding area is for occupying a larger area; therefore, the shapes or forms mentioned above are only illustrated as examples, but not to be construed as limitations thereof.

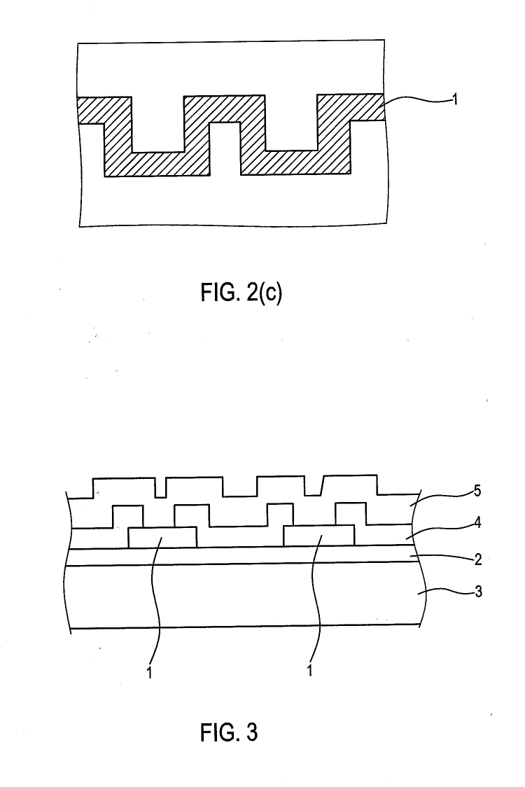

Referring to FIG. 3, based on the abovementioned manufacturing method, a TFT liquid crystal panel is obtained, and its cross-sectional structure mainly includes: a glass substrate 3; a gate protection layer 2 formed on an upper surface of the glass substrate 3; a part 1 of a metal line on a surrounding area is constituted of a metal layer formed on the gate protection layer 2; an insulating layer 4 formed on the gate protection layer 2 and the part 1 of the metal line on the surrounding area, the part 1 of the metal line on the surrounding area is partially covered by the insulating layer 4; and an ITO layer 5 formed on the insulating layer 4 and the part 1 of the metal line on the surrounding area, the ITO layer 5 is in contact with a part of the part 1 of the metal line on the surrounding area which is not covered by the insulating layer 4, an upper surface of the ITO layer 5 is uneven which is for increasing a contact area with a sealant (not shown in the figure).

Comparing with conventional technique, a liquid crystal display device, a liquid crystal panel and its manufacturing method of the present invention by having the parts of the metal lines on the surrounding area curved and extended, so that it is very easy for the surface of the TFT panel to be made uneven, in order to increase a contact area between the sealant and the ITO layer, therefore the adhesive strength of the sealant can be enhanced.

Note that the specifications relating to the above embodiments should be construed as exemplary rather than as limitative of the present invention, with many variations and modifications being readily attainable by a person of average skill in the art without departing from the spirit or scope thereof as defined by the appended claims and their legal equivalents.

1.-10. (canceled)

11. A manufacturing method for a liquid crystal panel, comprising:
disposing a first substrate;
disposing a second substrate;
disposing a liquid crystal and a sealant sandwiched between the first substrate and the second substrate, having a display area constituted by an arrangement of a plurality of devices and ITO areas, and a surrounding area around the display area formed on the second substrate, having metal lines arranged and disposed on the second substrate for electrically connecting to the devices,
wherein having parts of the metal lines on the surrounding area curved and extended, having an ITO layer formed the parts of the metal lines on the surrounding area, having a bottom of the sealant adhered with an upper surface of the ITO layer.

12. The manufacturing method for a liquid crystal panel as claimed in claim 11, wherein having shapes of the parts of the metal lines on the surrounding area a sawtooth shape, a wave shape, or a square-wave shape.

13. The manufacturing method for a liquid crystal panel as claimed in claim 11, wherein having the second substrate comprising a glass substrate and a gate protection layer formed on an upper surface of the glass substrate, such that the parts of the metal lines on the surrounding area is constituted by a metal layer formed on the gate protection layer.

14. The manufacturing method for a liquid crystal panel as claimed in claim 13, wherein having the second substrate further comprising an insulating layer formed on the gate protection layer and the parts of the metal lines on the surrounding area, such that the ITO layer formed on the insulating layer and the parts of the metal lines on the surrounding area.

15. A liquid crystal panel, comprising:
a first substrate;
a second substrate; and
a liquid crystal and a sealant sandwiched between the first substrate and the second substrate,
wherein a display area constituted by an arrangement of a plurality of devices and ITO areas, and a surrounding area around the display area formed on the second substrate, metal lines arranged and disposed on the second substrate for electrically connecting to the devices, and the parts of the metal lines on the surrounding area are curved and extended, an ITO layer is formed on the parts of the metal lines on the surrounding area, a bottom of the sealant is adhered with an upper surface of the ITO layer.

16. The liquid crystal panel as claimed in claim 15, wherein shapes of the parts of the metal lines on the surrounding area are a sawtooth shape, a wave shape, or a square-wave shape.

17. The liquid crystal panel as claimed in claim 15, wherein the second substrate comprises a glass substrate and a gate protection layer formed on an upper surface of the glass plate, the parts of the metal lines on the surrounding area are constituted of a metal layer formed on the gate protection layer.

18. The liquid crystal panel as claimed in claim 17, wherein the second substrate further comprises an insulating layer formed on the gate protection layer and the parts of the metal lines on the surrounding area, the ITO layer is formed on the insulating layer and the parts of the metal lines on the surrounding area.

19. The liquid crystal panel as claimed in claim 15, wherein the upper surface of the ITO layer is uneven.

20. A liquid crystal display device, wherein comprising the liquid crystal panel as claimed in claim 15.

21. The liquid crystal display device as claimed in claim 20, wherein shapes of the parts of the metal lines on the surrounding area are a sawtooth shape, a wave shape, or a square-wave shape.

22. The liquid crystal display device as claimed in claim 20, wherein the second substrate comprises a glass substrate and a gate protection layer formed on an upper surface of the glass plate, the parts of the metal lines on the surrounding area are constituted of a metal layer formed on the gate protection layer.

23. The liquid crystal display device as claimed in claim 22, wherein the second substrate further comprises an insulating layer formed on the gate protection layer and the parts of the metal lines on the surrounding area, the ITO layer is formed on the insulating layer and the parts of the metal lines on the surrounding area.

24. The liquid crystal display device as claimed in claim 20, wherein the upper surface of the ITO layer is uneven.
